(19) United States
(12) Patent Application Publication
(10) Pub. No.: US 2025/0141950 A1
(43) Pub. Date: May 1, 2025

(54) SYSTEMS AND METHODS FOR RECEIVING SERVICE IDENTIFIERS FOR QUALITY OF SERVICE DECISIONS

(71) Applicant: Verizon Patent and Licensing Inc., Basking Ridge, NJ (US)

(72) Inventors: Toby Varughese JOHN, Murphy, TX (US); Jayshree A. BHARATIA, Plano, TX (US); James S. ABRAHAM, Carrollton, TX (US); Bibi M. HAKIMZADEH, Fort Worth, TX (US)

(21) Appl. No.: 18/497,365

(22) Filed: Oct. 30, 2023

(51) Int. Cl. H04L 65/80; H04L 65/1016; H04L 65/1096

(52) U.S. Cl. CPC H04L 65/80; H04L 65/1016; H04L 65/1096

(57) ABSTRACT

In some implementations, an Internet Protocol multimedia subsystem (IMS) entity may receive, from a home subscriber service (HSS) or a unified data management (UDM), an identifier associated with a government emergency telecommunications service (GETS) subscription, wherein the identifier includes a selection prefix. The IMS entity may identify that a call is associated with GETS based on the identifier. The IMS identifier may transmit, to a network node, an indication that the call is associated with GETS.

### BACKGROUND

Wireless communication systems are widely deployed to provide various telecommunication services such as telephony, video, data, messaging, and broadcasts. A wireless network may include one or more network nodes that support communication for wireless communication devices, such as a user equipment (UE).

### BRIEF DESCRIPTION OF THE DRAWINGS

FIG. 1 is a diagram of an example associated with receiving service identifiers for quality of service (QOS) decisions.

FIG. 2 is a diagram of an example associated with receiving service identifiers for QoS decisions.

FIG. 3 is a diagram of an example environment in which systems and/or methods described herein may be implemented.

FIG. 4 is a diagram of example components of one or more devices of FIG. 3.

FIG. 5 is a flowchart of an example process associated with receiving service identifiers for QoS decisions.

### DETAILED DESCRIPTION OF EXAMPLE EMBODIMENTS

The following detailed description of example implementations refers to the accompanying drawings. The same reference numbers in different drawings may identify the same or similar elements.

A multimedia priority service (MPS) is a service that allows a UE to obtain and maintain radio resources and network resources with priority. The UE may obtain and maintain the radio resources and the network resources with priority during national security or emergency situations during which public land mobile network (PLMN) congestion may occur. The UE may be an MPS-subscribed UE, which may be an authorized UE with an MPS subscription. The UE may initiate and establish an MPS session (e.g., a voice session, a video session, and/or a data session) for which priority treatment may be applied for allocating and maintaining the radio resources and the network resources. MPS may be limited to national security or emergency preparedness (NS/EP) persons approved and subscribed to MPS mobile services.

A government emergency telecommunication service (GETS) is an emergency telephone service that prioritizes calls over wireline networks. GETS may support NS/EP requirements for the use of public, defense, or federal telephone networks by government departments, agencies, and other authorized users. GETS may be in effect all the time, and may not be contingent on a major disaster or attack taking place. GETS may use existing features and services of a public switched network with selected NS/EP augmentations and enhancements. GETS may provide authenticated access, enhanced routing, and priority treatment in local and long-distance telephone networks. GETS access may be via a dialing plan and a personal identification number (PIN). A user may receive an access card (e.g., a GETS card), which may be associated with both a universal GETS access number and the PIN. GETS may be an NS/EP landline service that is accessible to a landline or mobile telecommunication subscriber using the access card.

In a wireless network, some subscribers may experience NS/EP service outages. The NS/EP service outages may be due to the wireless network being unable to differentiate between separate services, such as MPS and GETS. The wireless network may use a same identifier for the separate services (e.g., a generic MPS identifier, which may be the same identifier used for both MPS and GETS), which may prevent the wireless network from identifying and treating separate services accordingly. Such NS/EP service outages may degrade an overall performance of the wireless network.

In order for the network to properly identify a GETS subscriber, in some implementations, a network node, may receive an indication of a service identifier and/or a service type. The indication may be received in a session initiation protocol (SIP) message. The network node may be a policy and charging rules function (PCRF) in a Fourth Generation (4G) wireless network. Alternatively, the network node may be a policy control function (PCF) or a session management function (SMF) in a Fifth Generation 5G wireless network. The network node may receive the indication from an Internet Protocol multimedia subsystem (IMS) entity, such as a proxy call session control function (P-CSCF), an interrogating call session control function (I-CSCF), a serving call session control function (S-CSCF), or a telephony application service (TAS). The service identifier may be associated with an MPS, a GETS, a mission critical service (MCS), an NS/EP service, or an enterprise service. The service type may be associated with a voice service, a data service, a video service, a messaging service, an over-the-top (OTT) media service, an Internet of Things (IoT) service, or a satellite service associated with a non-terrestrial telecommunication network. The service type may be associated with any service that traverses a communication medium. The network node may perform an action based on the service identifier and/or the service type. For example, the network node may perform a QoS decision based on the service identifier and/or the service type.

In some implementations, the indication of the service identifier and/or the service type may allow the network node to identify and treat separate services accordingly because such services are not equal. The network node may perform unique QoS decisions for different services and/or different types of services. The network node may be able to differentiate between different services (e.g., different NS/EP related services), such as MPS and GETS, based on the indication. As a result, for some subscribers, when switching to a new service plan, NS/EP service outages may be avoided because a wireless network may be able to identify and treat separate services differently, thereby improving an overall network performance.

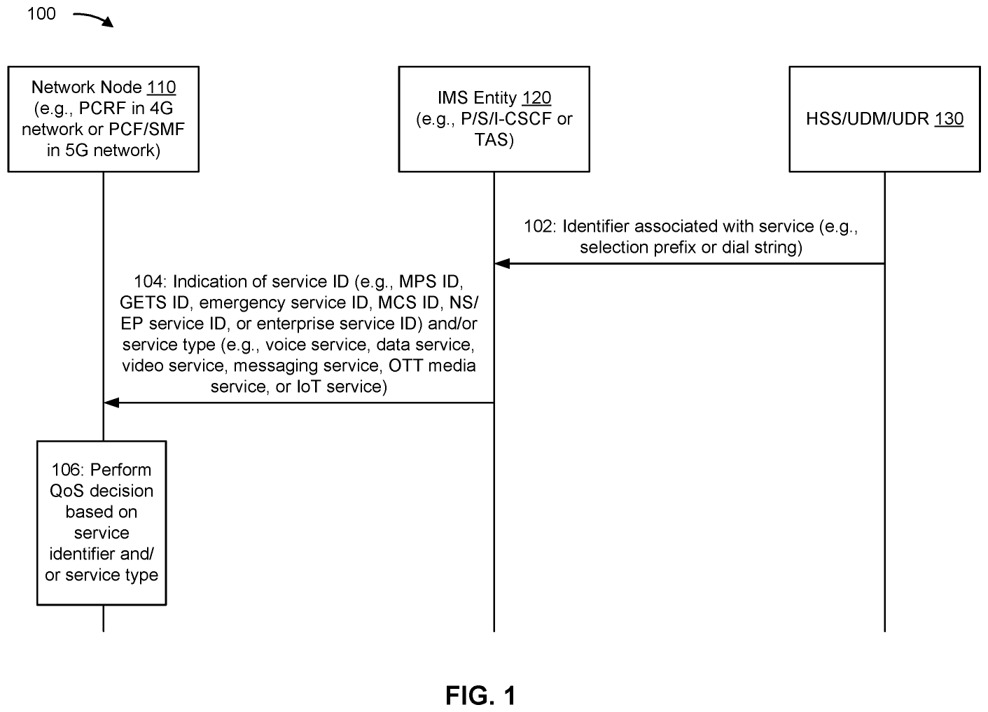

FIG. 1 is a diagram of an example 100 associated with receiving service identifiers for QoS decisions. As shown in FIG. 1, example 100 includes a network node 110 (e.g., a PCRF, a PCF 318, or an SMF 324) an IMS entity 120 (e.g., a P-CSCF, an S-CSCF, an I-CSCF, or a TAS), and a home subscriber service (HSS), a unified data management (UDM), or a unified data repository (HSS/UDM/UDR) 130. A UDR may be a backend database to a UDM. In a 4G wireless network, the network node 110 may be the PCRF. In a 5G wireless network, the network node 110 may be the PCF 318 or the SMF 324.

As shown by reference number 102, the IMS entity 120 may receive, from the HSS/UDM/UDR 130, an identifier associated with a service. The identifier may be a selection prefix (or dial string) that includes a string of numbers. The identifier may be associated with a service, such as an MPS, a GETS, an MCS, an NS/EP service, or an enterprise service. The IMS entity 120 may identify that a call is associated with a particular service based on the identifier. The IMS entity 120 may compare the identifier to a list of possible identifiers, and based on a match, the IMS entity 120 may be able to determine that the particular service associated with the identifier.

As shown by reference number 104, the network node 110 may receive, from the IMS entity 120, an indication of a service identifier and/or a service type. The service identifier may be associated with the MPS, the GETS, the MCS, the NS/EP service, or the enterprise service. The service type may be associated with a voice service, a data service, a video service, a messaging service, an OTT media service, or an IoT service. The indication may include a unique field value for each service and/or service type. The IMS entity 120 may convey the service identifier and/or the service type based on the selection prefix received from the HSS/UDM/UDR 130.

In some implementations, the indication may be a combination of the service identifier and the service type. For example, the indication of the service identifier and/or the service type may be a unique identifier for an MPS text service or an MPS video service. The indication may be an octet string or a text string that indicates that a session relates to an MPS text session or an MPS video session. As another example, the indication of the service identifier and/or the service type may be a unique identifier for a GETS voice service. The indication may be an octet string or a text string that indicates that a session relates to a GETS voice session. The indication may be an attribute value pair (AVP) value. Different AVP values may be used for MPS, GETS, and other services. The indication may be a unique identifier for each service and/or service type. In other words, each service and/or service type may be assigned a unique identification, which may allow the network node 110 to differentiate between different services and/or service types.

As shown by reference number 106, the network node 110 may perform a QoS decision based on the service identifier and/or the service type. The network node 110 may select different QoS parameters, depending on the service identifier and/or the service type. The network node 110 may apply separate QoS parameters for different service identifiers and/or different service types, such that separate services may be identified and treated accordingly since the services are not equal. The network node 110 may adjust one or more QoS parameters based on the service identifier and/or the service type. In a wireless network, the QoS may be obtained by the HSS, UDM, UDR, PCRF, and/or PCF.

In some implementations, in the 4G wireless network, the IMS entity, such as the P/S/I-CSCF or the TAS, may send a message with a service identifier and/or service type to the PCRF, and the PCRF may use such information to make the QoS decision. In some implementations, in the 5G wireless network, the IMS entity, such as the P/S/I-CSCF or the TAS, may send a message with a service identifier and/or service type to the PCF, and the PCF may use such information to make the QoS decision. As a result, the network may be able to identify and treat the two separate services accordingly, in terms of QoS handling, that were previously undistinguished from a network perspective.

As an example, the PCF/SMF may modify a 5G QoS. The PCF may be provided with identifiers by other data networks, such as an IMS network or any other network. Such identifiers may be related to the service and/or the service type. The SMF may include identifiers based on information provided by the HSS/UDM/UDR 130, or based on information obtained from an access and mobility management function (AMF). In some cases, the indication of the service identifier and/or the service type may be specified or indicated in the HSS/UDM/UDR 130, or alternatively, the indication of the service identifier and/or the service type may be specified or indicated in subscriber repository information.

In some implementations, the IMS entity 120 may provide the indication of the service identifier and/or the service type to the network node 110 as part of a larger signaling flow associated with MPS, GETS, and other services. In other words, the indication of the service identifier and/or the service type may be only one specific indication that is used during an establishment of the MPS or the GETS, which may involve a plurality of messages between various different entities in the 4G wireless network or the 5G wireless network.

In some implementations, the IMS entity 120 (e.g., the P/S/I-CSCF or the TAS) may receive, from the HSS/UDM/UDR 130, an identifier associated with a GETS subscription. The identifier may include a selection prefix (or dial string). The selection prefix may be a string of numbers. The IMS entity may identify that a call is associated with GETS based on the identifier. The call may be a GETS call based on the identifier. The IMS entity may compare the identifier to a list of possible identifiers, and based on a match, the IMS entity may be able to determine that the identifier is related to GETS. The IMS entity may transmit, to the PCRF in the 4G wireless network or to the PCF/SMF in the 5G wireless network, an indication that the call is associated with GETS. The PCRF or the PCF/SMF may perform a QoS decision based on the indication that the call is associated with GETS.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

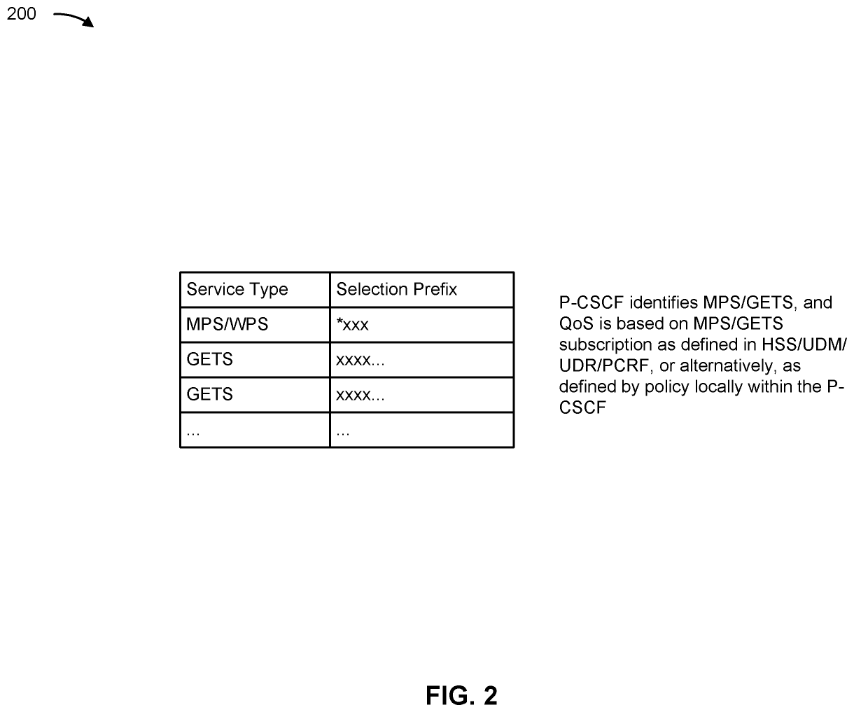

FIG. 2 is a diagram of an example 200 associated with receiving service identifiers for QoS decisions.

As shown in FIG. 2, a P-CSCF may identify a service type based on a selection prefix. For example, the P-CSCF may identify a service type of MPS or wireless priority service (WPS) based on a selection prefix of *xxx, where x is a certain number. A WPS may be a program that authorizes cellular communications service providers to prioritize calls over wireless networks. Authorized users may dial *xxx on a WPS enabled device to receive calling queue priority. A WPS call may preempt calls in progress, and may provide priority status over cellular communications networks. The WPS call may receive a calling queue priority over regular calls, thereby increasing a probability that the WPS call gets through the network, even with congestion. As another example, the P-CSCF may identify a service type of GETS based on a selection prefix of xxxx, where x is a certain number. In these cases, the P-CSCF may provide information to a PCRF/PCF to identify a call/session as MPS/GETS, and the PCRF/PCF may provide a QoS that is appropriate based on the service type. In these examples, an IMS network function, such as the P-CSCF, may differentiate MPS, GETS, or MCS based on a dial string, and then communicate to adjacent network functions accordingly.

In some implementations, an identifier may be inserted into a header before the header is received by the P-CSCF, in which case no dial string may be needed. Further, existing network function interfaces/processes may be changed due to changed priority based on GETS identification. For example, when GETS is identified based on the dial string, a priority level associated with GETS may be increased using changed network function interfaces/processes.

In some implementations, an MPS QOS may be based on an MPS subscription, as defined in an HSS, a UDM, and/or a UDR. Thus, the P-CSCF may identify MPS/GETS, and a QoS may be based on an MPS/GETS subscription, as defined in an HSS/UDM/UDR/PCRF, or alternatively, as defined by policy locally within the P-CSCF. The P-CSCF may obtain subscriber QoS information during registration. GETS subscriber information may not be stored in the HSS/UDM/UDR, but recognition and QoS support may be available in the P-CSCF and the PCRF.

As indicated above, FIG. 2 is provided as an example. Other examples may differ from what is described with regard to FIG. 2.

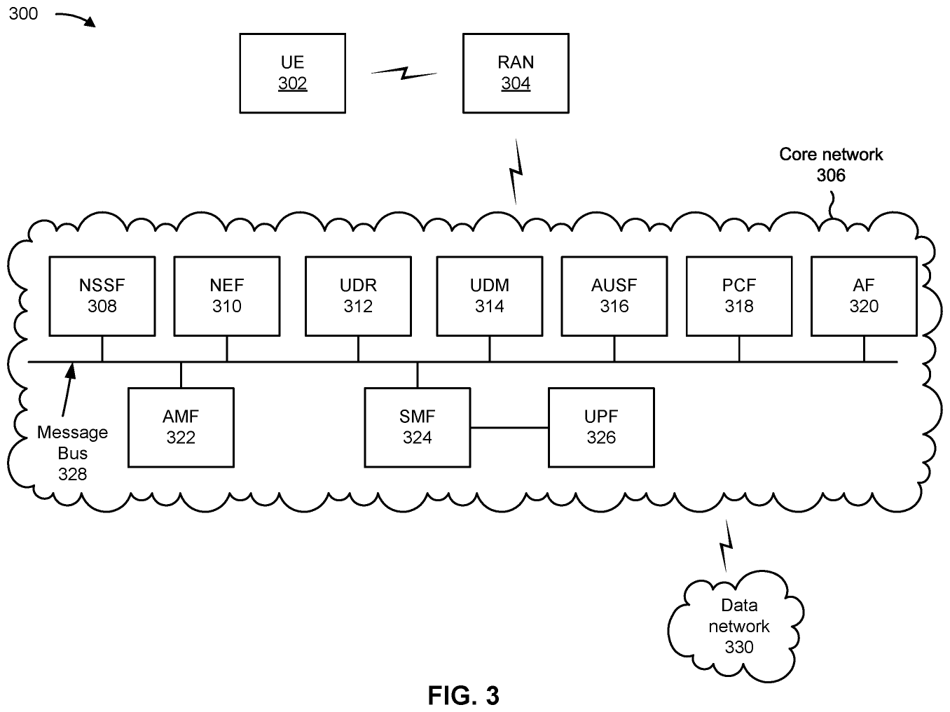

FIG. 3 is a diagram of an example environment 300 in which systems and/or methods described herein may be implemented. As shown in FIG. 3, example environment 300 may include a UE 302, a radio access network (RAN) 304, a core network 306, and a data network 330. Devices and/or networks of example environment 300 may interconnect via wired connections, wireless connections, or a combination of wired and wireless connections.

The UE 302 may include one or more devices capable of receiving, generating, storing, processing, and/or providing information, such as information described herein. For example, The UE 302 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 304 may support, for example, a cellular radio access technology (RAT). The RAN 304 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 302. A base station may be a disaggregated base station. The disaggregated base station may be configured to utilize a protocol stack that is physically or logically distributed among two or more nodes, which may include a radio unit (RU), a distributed unit (DU), and a centralized unit (CU). The RAN 304 may transfer traffic between the UE 302 (e.g., using a cellular RAT), one or more base stations (e.g., using a wireless interface or a backhaul interface, such as a wired backhaul interface), and/or the core network 306. The RAN 304 may provide one or more cells that cover geographic areas.

In some implementations, the RAN 304 may perform scheduling and/or resource management for the UE 302 covered by the RAN 304 (e.g., the UE 302 covered by a cell provided by the RAN 304). In some implementations, the RAN 304 may be controlled or coordinated by a network controller, which may perform load balancing, network-level configuration, and/or other operations. The network controller may communicate with the RAN 304 via a wireless or wireline backhaul. In some implementations, the RAN 304 may include a network controller, a self-organizing network (SON) module or component, or a similar module or component. In other words, the RAN 304 may perform network control, scheduling, and/or network management functions (e.g., for uplink, downlink, and/or sidelink communications of the UE 302 covered by the RAN 304).

In some implementations, the core network 306 may include an example functional architecture in which systems and/or methods described herein may be implemented. For example, the core network 306 may include an example architecture of a 5G next generation (NG) core network included in a 3G wireless telecommunications system. While the example architecture of the core network 306 shown in FIG. 3 may be an example of a service-based architecture, in some implementations, the core network 306 may be implemented as a reference-point architecture and/or a 4G core network, among other examples.

As shown in FIG. 3, the core network 306 include a number of functional elements. The functional elements may include, for example, a network slice selection function (NSSF) 308, a network exposure function (NEF) 310, a UDR 312, a UDM 314, an authentication server function (AUSF) 316, a PCF 318, an application function (AF) 320, an AMF 322, an SMF 324, and/or a user plane function (UPF) 326. These functional elements may be communicatively connected via a message bus 328. Each of the functional elements shown in FIG. 3 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 308 may include one or more devices that select network slice instances for the UE 302. The NSSF 308 may allow an operator to deploy multiple substantially independent end-to-end networks potentially with the same infrastructure. In some implementations, each slice may be customized for different services. The NEF 310 may include one or more devices that support exposure of capabilities and/or events in the wireless telecommunications system to help other entities in the wireless telecommunications system discover network services.

The UDR 312 may include one or more devices that provide a converged repository, which may be used by network functions to store data. For example, a converged repository of subscriber information may be used to service a number of network functions. The UDM 314 may include one or more devices to store user data and profiles in the wireless telecommunications system. The UDM 314 may generate authentication vectors, perform user identification handling, perform subscription management, and perform other various functions. The AUSF 316 may include one or more devices that act as an authentication server and support the process of authenticating the UE 302 in the wireless telecommunications system.

The PCF 318 may include one or more devices that provide a policy framework that incorporates network slicing, roaming, packet processing, and/or mobility management, among other examples. The AF 320 may include one or more devices that support application influence on traffic routing, access to the NEF 310, and/or policy control, among other examples. The AMF 322 may include one or more devices that act as a termination point for non-access stratum (NAS) signaling and/or mobility management, among other examples. The SMF 324 may include one or more devices that support the establishment, modification, and release of communication sessions in the wireless telecommunications system. For example, the SMF 324 may configure traffic steering policies at the UPF 326 and/or may enforce UE internet protocol (IP) address allocation and policies, among other examples. The UPF 326 may include one or more devices that serve as an anchor point for intra-RAT and/or inter-RAT mobility. The UPF 326 may apply rules to packets, such as rules pertaining to packet routing, traffic reporting, and/or handling user plane QoS, among other examples. The message bus 328 may represent a communication structure for communication among the functional elements. In other words, the message bus 328 may permit communication between two or more functional elements.

The data network 330 may include one or more wired and/or wireless data networks. For example, the data network 330 may include an IMS, a PLMN, a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of example environment 300 may perform one or more functions described as being performed by another set of devices of example environment 300.

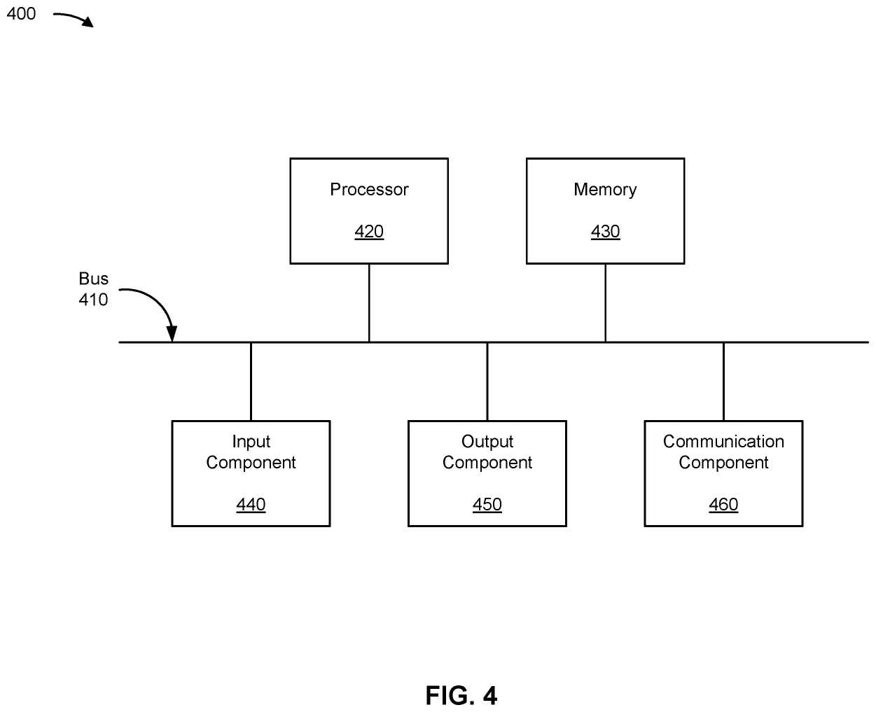

FIG. 4 is a diagram of example components of a device 400 associated with receiving service identifiers for QoS decisions. The device 400 may correspond to a network node (e.g., network node 110, such as a PCRF, PCF 318, or SMF 324). Alternatively, the device 400 may correspond to an IMS entity (e.g., IMS entity 120, such as a P-CSCF, an S-CSCF, an I-CSCF, or a TAS). In some implementations, the network node or the IMS entity may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

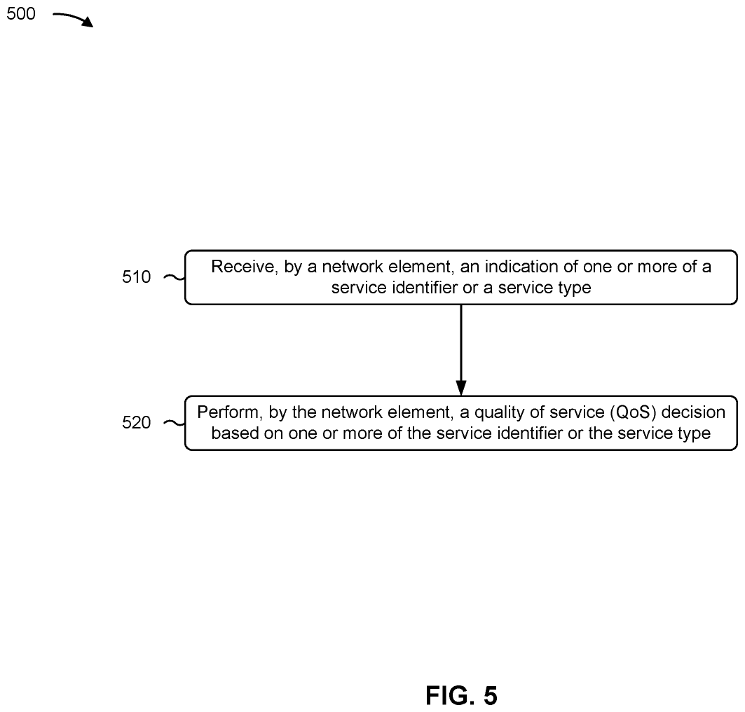

FIG. 5 is a flowchart of an example process 500 associated with receiving service identifiers for QoS decisions. In some implementations, one or more process blocks of FIG. 5 may be performed by a network node (device 400), such as a PCRF, a PCF (e.g., PCF 318), or an SMF (e.g., SMF 324). Alternatively, one or more process blocks of FIG. 5 may be performed by an IMS entity (device 400), such as a P-CSCF, an S-CSCF, an I-CSCF, or a TAS. In some implementations, one or more process blocks of FIG. 5 may be performed by another network node or a group of network nodes separate from or including the network node. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving, by a network node, an indication of a service identifier and/or a service type (block 510). The network node may be a PCRF in a 4G wireless network. Alternatively, the network node may be a PCF or an SMF in a 5G wireless network. The network node may receive the indication from an IMS entity, such as a P-CSCF, an I-CSCF, an S-CSCF, or a TAS. The service identifier may be associated with an MPS, a GETS, an MCS, an NS/EP service, or an enterprise service. The service type may be associated with a voice service, a data service, a video service, a messaging service, an OTT media service, or an IoT service.

As shown in FIG. 5, process 500 may include performing, by the network node, a QoS decision based on the service identifier and/or the service type (block 520). The network node may select different QoS parameters, depending on the service identifier and/or the service type. The network node may apply separate QoS parameters for different service identifiers and/or different service types, such that separate services may be identified and treated accordingly since the services are not equal.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by an Internet Protocol multimedia subsystem (IMS) entity and from a home subscriber service (HSS) or a unified data management (UDM), an identifier associated with a government emergency telecommunications service (GETS) subscription, wherein the identifier includes a selection prefix;
identifying, by the IMS entity, that a call is associated with GETS based on the identifier; and
transmitting, by the IMS entity and to a network node, an indication that the call is associated with GETS.

2. The method of claim 1, wherein the IMS entity is a proxy call session control function (P-CSCF), an interrogating call session control function (I-CSCF), or a serving call session control function (S-CSCF).

3. The method of claim 1, wherein the IMS entity is a telephony application service (TAS).

4. The method of claim 1, wherein the network node is a policy and charging rules function (PCRF) in a Fourth Generation (4G) wireless network.

5. The method of claim 1, wherein the network node is a policy control function (PCF) or a session management function (SMF) in a Fifth Generation (5G) wireless network.

6. The method of claim 1, wherein a quality of service (QOS) decision is based on the indication that the call is associated with GETS.

7. A method, comprising:
receiving, by a network node, an indication of one or more of a service identifier or a service type; and
performing, by the network node, a quality of service (QOS) decision based on one or more of the service identifier or the service type.

8. The method of claim 7, wherein the service identifier is associated with one of:
a multimedia priority service (MPS),
a government emergency telecommunications service (GETS),
an emergency service,
a mission critical service (MCS),
a national security or emergency preparedness (NS/EP) service, or
an enterprise service.

9. The method of claim 7, wherein the service type is associated with one of:
a voice service,
a data service,
a video service,
a messaging service,
an over-the-top (OTT) media service,
an Internet of Things (IoT) service, or
a satellite service associated with a non-terrestrial telecommunication network.

10. The method of claim 7, wherein the indication is received from an Internet Protocol multimedia subsystem (IMS) entity.

11. The method of claim 10, wherein the IMS entity is a proxy call session control function (P-CSCF), an interrogating call session control function (I-CSCF), or a serving call session control function (S-CSCF).

12. The method of claim 10, wherein the IMS entity is a telephony application service (TAS).

13. The method of claim 7, wherein the network node is a policy and charging rules function (PCRF) in a Fourth Generation (4G) wireless network.

14. The method of claim 7, wherein the network node is a policy control function (PCF) or a session management function (SMF) in a Fifth Generation (5G) wireless network.

15. A network node, comprising:
one or more processors configured to:
receive, from an Internet Protocol multimedia subsystem (IMS) entity, an indication of one or more of a service identifier or a service type; and
adjust a quality of service (QOS) parameter based on one or more of the service identifier or the service type.

16. The network node of claim 15, wherein the service identifier is associated with one of:
a multimedia priority service (MPS),
a government emergency telecommunications service (GETS),
an emergency service,
a mission critical service (MCS),
a national security or emergency preparedness (NS/EP) service, or
an enterprise service.

17. The network node of claim 15, wherein the service type is associated with one of:
a voice service,
a data service,
a video service,
a messaging service,
an over-the-top (OTT) media service,
an Internet of Things (IoT) service, or
a satellite service associated with a non-terrestrial telecommunication network.

18. The network node of claim 15, wherein the IMS entity is a proxy call session control function (P-CSCF), an interrogating call session control function (I-CSCF), or a serving call session control function (S-CSCF).

19. The network node of claim 15, wherein the IMS entity is a telephony application service (TAS).

20. The network node of claim 15, wherein:
the network node is a policy and charging rules function (PCRF) in a Fourth Generation (4G) wireless network; or
the network node is a policy control function (PCP) or a session management function (SMF) in a Fifth Generation (5G) wireless network.
